(19) United States
(12) Patent Application Publication
(10) Pub. No.: US 2009/0197566 A1
(43) Pub. Date: Aug. 6, 2009

(54) SYSTEM FOR TRANSMITTING EMERGENCY INFORMATION SUCH AS EARTHQUAKE

(76) Inventor: Minoru ITO, Shiga (JP)

Correspondence Address: MCDERMOTT WILL & EMERY LLP, 600 13TH STREET, NW, WASHINGTON, DC, 20005-3096, US

(21) Appl. No.: 12/332,771

(22) Filed: Dec. 11, 2008

(30) Foreign Application Priority Data
Feb. 1, 2008 (JP) 2008-022538

(51) Int. Cl. H04M 11/04

(52) U.S. Cl. 455/404.1

(57) ABSTRACT

The emergency information transmission system includes: an emergency information transmission device for transmitting emergency information varying among radio base stations; and a radio base station for transmitting the emergency information received from the emergency information transmission device to all cellular phone terminals present within its coverage in unison.

### CROSS-REFERENCE TO RELATED APPLICATIONS

This application claims priority under 35 U.S.C. §119 on Patent Application No. 2008-22538 filed in Japan on Feb. 1, 2008, the entire contents of which are hereby incorporated by reference.

### BACKGROUND OF THE INVENTION

The present invention relates to a system for transmitting emergency information such as earthquake information, and an electronic device for such a system.

Conventionally, as an earthquake prediction method, generally known is a method in which the difference in propagation velocity between a P wave (primary wave; longitudinal wave; preliminary tremor) and an S wave (secondary wave; transverse wave; principal shock) is used to detect a P wave and warn citizens of an earthquake before arrival of an S wave (see Patent Documents 1 to 3).

As methods for notifying citizens of emergency information, other than those using television, the radio, community wired broadcasting for disaster prevention, wireless broadcasting for disaster prevention and the like, known are methods using the Internet, public lines, cellular phones and PDAs to notify citizens of emergency information by means of sound, vibration, textual information and the like (see Patent Documents 2 to 9).
Patent Document 1: Japanese Laid-Open Patent Publication No. 11-160447
Patent Document 2: Japanese Laid-Open Patent Publication No. 2001-307265
Patent Document 3: Japanese Laid-Open Patent Publication No. 2004-184164
Patent Document 4: Japanese Laid-Open Patent Publication No. 2001-216591
Patent Document 5: Japanese Laid-Open Patent Publication No. 4-329035
Patent Document 6: Japanese Laid-Open Patent Publication No. 2005-174111
Patent Document 7: Japanese Laid-Open Patent Publication No. 2000-244971
Patent Document 8: Japanese Laid-Open Patent Publication No. 2005-295290
Patent Document 9: Japanese Laid-Open Patent Publication No. 2006-260497

However, such disclosed emergency information transmission systems have problems as follows.

Normal fixed phones and cellular phones are systems made up for the purpose of person-to-person conversation and not adapted to transmit emergency information in unison and simultaneously. When e-mail is used to transmit the same information to individuals, it is necessary to distribute the information to the individuals' mail addresses in sequence. Hence, as in the above case, e-mail is not adapted to transmit emergency information in unison and simultaneously, either. The Internet has a mechanism in which a person who needs information accesses the Internet to acquire the information, and thus as in the above case, is not adapted to transmit emergency information in unison and simultaneously, either.

The current mechanism of transmitting earthquake alarm information to a cellular phone from an earthquake alarm device by e-mail will be described with reference to FIG. 5.

The earthquake alarm device transmits the mail address of a cellular phone terminal to which transmission of earthquake alarm information is desired, together with earthquake alarm details, to a mail server in a cellular phone circuit. After checking whether or not the received mail address is a mail address of its cellular phone subscriber, the mail server stores the earthquake alarm details in a RECEIVE box having the mail address in question, among RECEIVE and SEND boxes having mail addresses set for respective cellular phone terminals in the mail server.

Thereafter, the mail server searches a mail address-correspondence database to obtain the phone number of the cellular phone terminal corresponding to the mail address. A switchboard then searches a home memory to check the location registration area of the cellular phone terminal. After the check, a general call is made to the cellular phone terminal via a radio base station. Once receiving a response from the cellular phone terminal, the radio base station performs user verification and establishes a communication path, and the mail server transmits the earthquake alarm details to the cellular phone terminal.

Hence, in emergency information transmission systems using cellular phones and PDAs as described above, the same emergency information must be repeatedly transmitted in sequence to cellular phone terminals and PDAs to which transmission of the emergency information is desired. As the number of terminals to which emergency information is to be transmitted increases, a considerably long time is necessary to transmit the emergency information and the processing required becomes enormous. This makes it difficult to secure the real-time property, and increases the system cost.

Another problem is that it is necessary to change the details of emergency information required depending on the positional relationship between the person who receives emergency information and the epicenter of an earthquake. That is, while it is necessary to deliver correct emergency information on an earthquake to persons who are near the earthquake's epicenter, it is unnecessary to deliver it to persons who are far away from the earthquake's epicenter and thus will be hardly affected by the earthquake. In particular, in conveying emergency information to persons carrying cellular phone terminals, how these persons who are in various places of the country should be notified of emergency information necessary for them presents a large problem.

In an emergency notification system using PHS (personal handy-phone system) disclosed in Patent Document 4, the positions of PHS child units are measured and registered in a data base table, and emergency messages classified according to the positional relationship between the PHS child units and a fire area are transmitted to the PHS child units. In this system, emergency messages must be individually transmitted to the respective PHS terminals, and thus, one-time transmission of emergency messages to a plurality of PHS terminals is not permitted. Also, detailed positional information of PHS terminals must be managed individually. Hence, if the number of cellular phone terminals to which notification must be made is considerably great, an enormous amount of lo processing will be necessary for transmission of emergency messages and updating of positional information. This makes it difficult to secure the real-time property, and raises the problem of increasing the system cost.

In a radio paging receiver disclosed in Patent Document 5, an ID number is added to a common number as a subscriber phone number, and a specific number (0, for example) in the ID number is exclusively used for a general call. Hence, the cellular phone terminals to which notification is made in the event of an emergency are fixed, like those of family members. This system is therefore unsuitable for the case of transmitting emergency information to an indefinite number of persons carrying cellular phone terminals properly based on the positions of the cellular phone terminals.

In urgent information transmission systems using PDAs disclosed in Patent Documents 6, 8 and 9, emergency information is transmitted to only subscriber PDAs. No consideration is made on transmission of emergency information to an indefinite number of persons carrying cellular phone terminals.

In information providing systems disclosed in Patent Documents 7 and 9, information is sent in the form of a text by e-mail using the current e-mail system. Such systems therefore raise a problem in securing the real-time property in communications.

### SUMMARY OF THE INVENTION

An object of the present invention is providing a system for transmitting correct emergency information on an earthquake and the like to persons carrying cellular phone terminals quickly in unison according to the positional relationships between the cellular phone terminals and the epicenter of the earthquake.

According to the present invention, a common number or code dedicated to emergency notification that is normally unused is embedded in all cellular phone terminals. Once receiving an emergency notification signal from a radio base station, cellular phone terminals receive emergency information without the necessity of procedures such as response to the radio base station and user verification, to thereby permit in-unison simultaneous transmission of emergency information.

Also, radio base stations for cellular phones are provided with their unique numbers or codes, and an emergency information transmission device transmits emergency information varying among the radio base stations. This permits transmission of proper emergency information to persons carrying cellular phones present within the coverage of each radio base station.

The emergency information transmission system of the present invention uses widely available cellular phones to transmit emergency information proper for each radio base station to persons carrying cellular phone terminals in unison simultaneously before damage occurs. Naturally, it is also possible to transmit evacuation information, danger avoidance information and the like to persons carrying cellular phone terminals after occurrence of damage.

In the case of an earthquake, it is possible to inform persons carrying cellular phone terminals present within the coverage of a radio base station for cellular phones of the arrival time of an earthquake before the earthquake arrives. This can contribute to permitting evacuation to a safe place and minimizing damage of the earthquake.

The emergency information transmission system of the present invention transmits emergency information such as earthquake information to persons carrying cellular phone terminals in a relevant area in union before damage occurs, and thus is very effective as the means of permitting evacuation to a safe place and minimizing damage.

### BRIEF DESCRIPTION OF THE DRAWINGS

FIG. 1 is a block diagram of an emergency information transmission system of Embodiment 1 of the present invention.

FIG. 2 is a flowchart showing the operation of the emergency information transmission system of Embodiment 1.

FIG. 3 is a flowchart showing the operation of an emergency information transmission system of Embodiment 2 of the present invention.

FIG. 4 is a block diagram of an electronic device for implementing Embodiments 1 and 2 of the present invention.

FIG. 5 is a view illustrating a current system for transmitting emergency information from an earthquake alarm device to a cellular phone by e-mail.

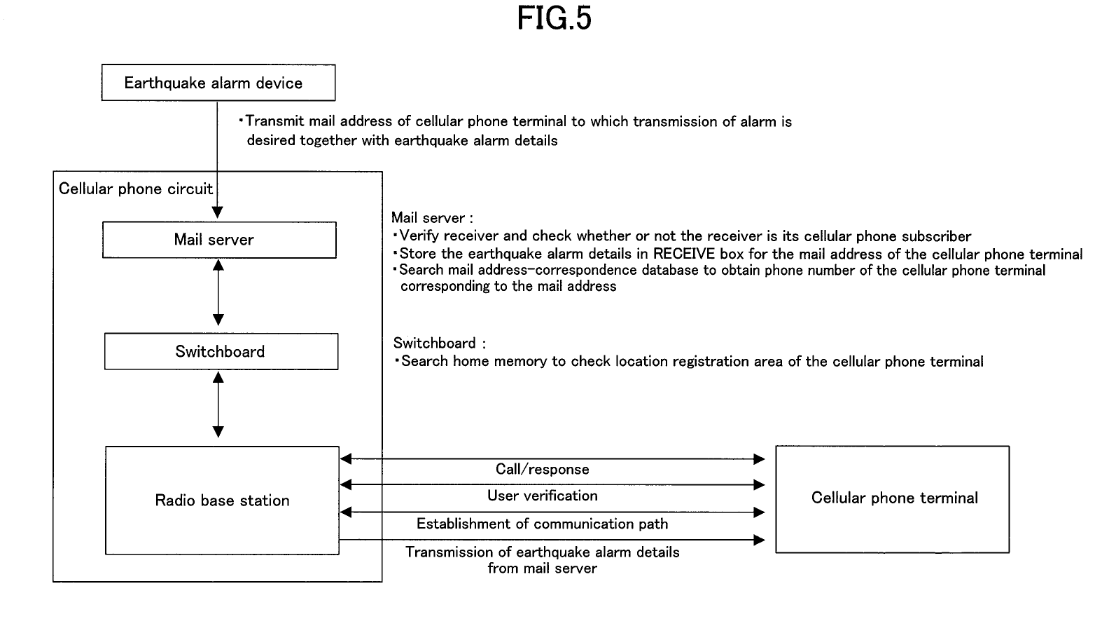

### DESCRIPTION OF THE PREFERRED EMBODIMENTS

### Embodiment 1

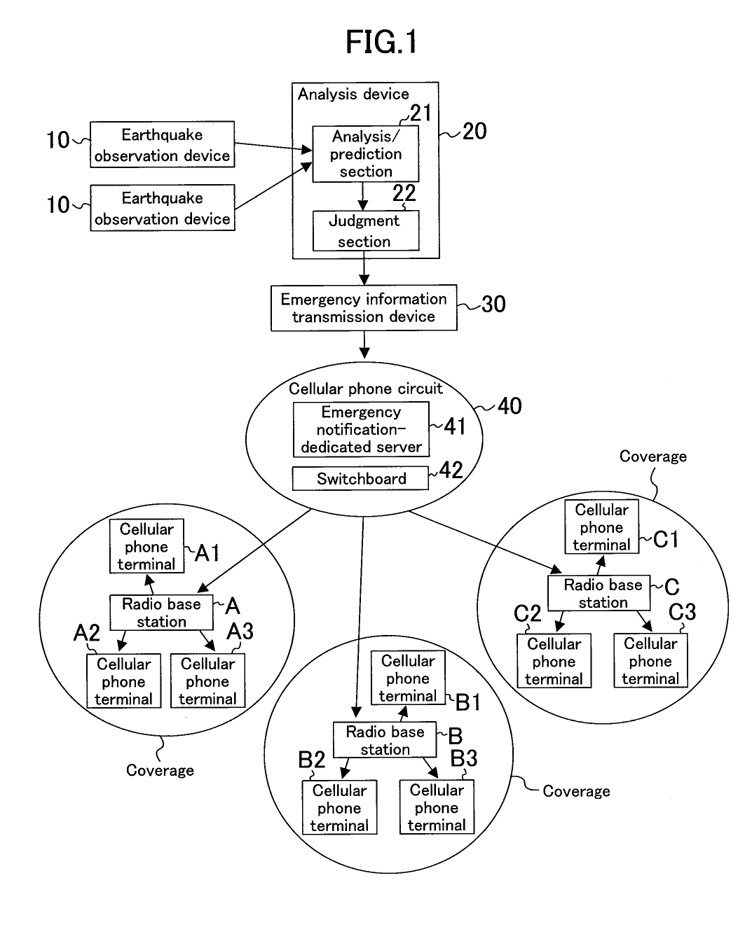

FIG. 1 is a view showing a configuration of an emergency information transmission system of Embodiment 1 of the present invention. The emergency information transmission system of FIG. 1 calculates the arrival time of an earthquake for each of radio base stations A, B and C for cellular phones based on the earthquake focus position information and the positional information of the radio base stations using earthquake observation information obtained from earthquake observation devices 10, and transmits emergency information such as an earthquake alarm, the earthquake arrival time and the like to cellular phone terminals A1 to A3, B1 to B3 and C1 to C3 present within the coverages of the radio base stations A, B and C. The emergency information transmission system of FIG. 1 includes: the plurality of earthquake observation devices 10 for observing an earthquake under fixed-point observation; an analysis device 20 for analyzing earthquake observation information obtained by the earthquake observation devices 10; an emergency information transmission device 30 for transmitting emergency information varying among the radio base stations A, B and C prepared based on the analysis/prediction results from the analysis device 20; a cellular phone circuit 40 for controlling the transmission of the emergency information varying among the radio base stations A, B and C transferred from the emergency information transmission device 30 to the corresponding radio base stations A, B and C; the plurality of radio base stations A, B and C for transmitting the emergency information received from the cellular phone circuit 40 to the plurality of cellular phone terminals A1 to A3, B1 to B3 and C1 to C3 present within the respective coverages in unison; and the plurality of cellular phone terminals A1 to A3, B1 to B3 and C1 to C3 for performing earthquake alarm operation upon receipt of the emergency information transmitted from the respective radio base stations A, B and C.

The cellular phone terminals A1 to A3, B1 to B3 and C1 to C3 hold a common number or code dedicated to emergency notification used only on the occasion of notification of emergency such as an earthquake, in addition to the phone number unique to each subscriber. In other words, all the cellular phone terminals A1 to A3, B1 to B3 and C1 to C3 have the same common number or code dedicated to emergency notification. Also, the cellular phone terminals A1 to A3, B1 to B3 and C1 to C3 receive emergency information after receipt of an emergency notification signal from the radio base stations A, B and C, and perform alarm operation immediately.

In other words, after receiving an emergency notification signal from the radio base stations A, B and C, the cellular phone terminals A1 to A3, B1 to B3 and C1 to C3 do not follow the procedures of response, user verification and the like as in normal e-mail reception. As the emergency notification signal, the common number or code dedicated to emergency notification described above may be used.

The earthquake observation devices 10, provided with various types of sensors for detecting the properties of a P wave such as the period, the amplitude and the incidence direction, output earthquake observation information detected with the sensors to the analysis device 20 via dedicated lines.

The analysis device 20, composed of an information processing device such as a computer, includes an analysis/prediction section 21 and a judgment section 22. The analysis/prediction section 21 analyzes the earthquake observation information from the earthquake observation devices 10 to estimate the location of the earthquake focus, the magnitude of the earthquake and the like, predict propagation of a P wave and an S wave and predict the arrival time of the S wave for each of the radio base stations A, B and C within an area to be affected by the earthquake. The judgment section 22 judges the necessity of alarming from the results of estimation by the analysis/prediction section 21 for each of the radio base stations A, B and C within an area to be affected by the earthquake.

The emergency information transmission device 30 prepares emergency information including the arrival time of an S wave and the like for each of the radio base stations A, B and C, and transmits the emergency information varying from a base station to another to the radio base stations A, B and C via the cellular phone circuit 40. For example, unique numbers or codes may be allocated to the radio base stations A, B and C, and in transmission of the emergency information, the unique numbers or codes of the radio base stations A, B and C may be used, or numbers or codes obtained by combining such unique numbers or codes and the common number or code dedicated to emergency notification may be used. This emergency information on an earthquake alarm may include sound data, text data, image data, vibration control data, sound/display control data and the like.

Once receiving its specific emergency information, the radio base station A transmits the emergency notification signal and the emergency information to all the cellular phone terminals A1 to A3 present within the coverage of the radio base station A in unison. Each of the cellular phone terminals A1 to A3, having received the emergency notification signal, does not send back a response as in normal phone call and mail reception, but receives the emergency information upon receipt of the emergency notification signal, and gives an alarm by vibration, announces an alarm and the earthquake arrival time via the speaker, and/or displays earthquake alarm-related information such as the evacuation place on the display panel.

Like the radio base station A, the other radio base stations B and C also transmit the emergency notification signal and the emergency information to all the cellular phone terminals B1 to B3 and C1 to C3 present within the respective coverages of the radio base station B and C in unison once receiving their specific emergency information.

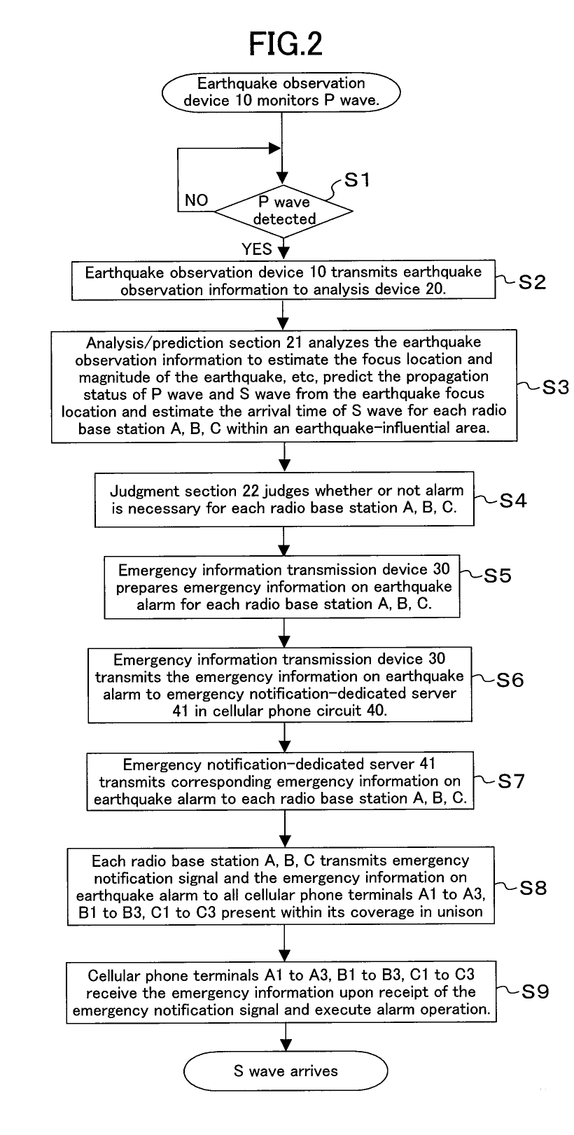

FIG. 2 is a flowchart showing the operation of the emergency information transmission system configured as described above. The earthquake observation devices 10 monitor P waves at any time, and once detecting a P wave (YES in step S1), transmit earthquake observation information to the analysis device 20 (step S2). The analysis/prediction section 21 of the analysis device 20 analyzes the earthquake observation information from the earthquake observation devices 10, to estimate the location of the earthquake focus, the magnitude of the earthquake and the like, predict the propagation status of the P wave and S wave from the location of the earthquake focus and estimate the arrival time of the S wave for each of the radio base stations A, B and C within an area to be affected by the earthquake, and transfers the estimated data to the judgment section 22 (step S3).

The judgment section 22 judges whether or not an alarm is necessary for each of the radio base stations A, B and C based on the estimated data from the analysis/prediction lo section 21 (step S4). The emergency information transmission device 30 prepares emergency information on the earthquake alarm for each of the radio base stations A, B and C required based on the judgment on the necessity of the alarm (step S5) and transmits the emergency information to an emergency notification-dedicated server 41 in the cellular phone circuit 40 (step S6).

The emergency notification-dedicated server 41 transmits the corresponding emergency information on the earthquake alarm to each of the radio base stations A, B and C (step S7). The radio base station A, B, C, having received the emergency information on the earthquake alarm, transmits the emergency notification signal and the emergency information on the earthquake alarm to all the cellular phone terminals A1 to A3, B1 to B3, C1 to C3 present within its coverage in unison (step S8). The cellular phone terminals A1 to A3, B1 to B3, C1 to C3 receive the emergency information upon receipt of the emergency notification signal and execute alarm operation immediately (step S9).

Hence, persons carrying the cellular phone terminals A1 to A3, B1 to B3 and C1 to C3 can be notified of earthquake information before arrival of an S wave, and thus the damage of the earthquake people near the earthquake's epicenter may suffer can be minimized.

### Embodiment 2

Embodiment 2 refers to an emergency information transmission system in which fixed information such as an evacuation place for each of radio base stations within a location registration area is previously sent to a cellular phone terminal, to thereby reduce the data amount of emergency information and thus shorten the time for which the cellular phone terminal receives the emergency information. The entire configuration of this system is substantially the same as that of FIG. 1.

In Embodiment 2, each of the cellular phone terminals A1 to A3, B1 to B3 and C1 to C3 periodically performs cell search to receive “notice information”, including area information required for location registration, from any of the radio base stations A, B and C. Only when the area information is different from the location registration area registered previously, the cellular phone terminal A1 to A3, B1 to B3, C1 to C3 transmits the International Mobile Subscriber Identity (IMSI), which is ID information unique to the cellular phone terminal, to a switchboard 42 via the radio base station A, B, C, to request for location registration. The switchboard 42 updates the location registration area in the home memory and simultaneously transmits emergency-related information to the cellular phone terminal.

The cellular phone terminal A1 to A3, B1 to B3, C1 to C3 stores the emergency-related information received in substantially the same procedures as those for normal e-mail in the memory therein. Once receiving an emergency notification signal from the radio base station A, B, C, the cellular phone terminal A1 to A3, B1 to B3, C1 to C3 reads out a portion of the emergency-related information corresponding to the relevant radio base station A, B, C, and displays the portion of the information on the display panel. As the emergency-related information, evacuation places and dangerous places for the respective radio base stations A, B and C may be effective.

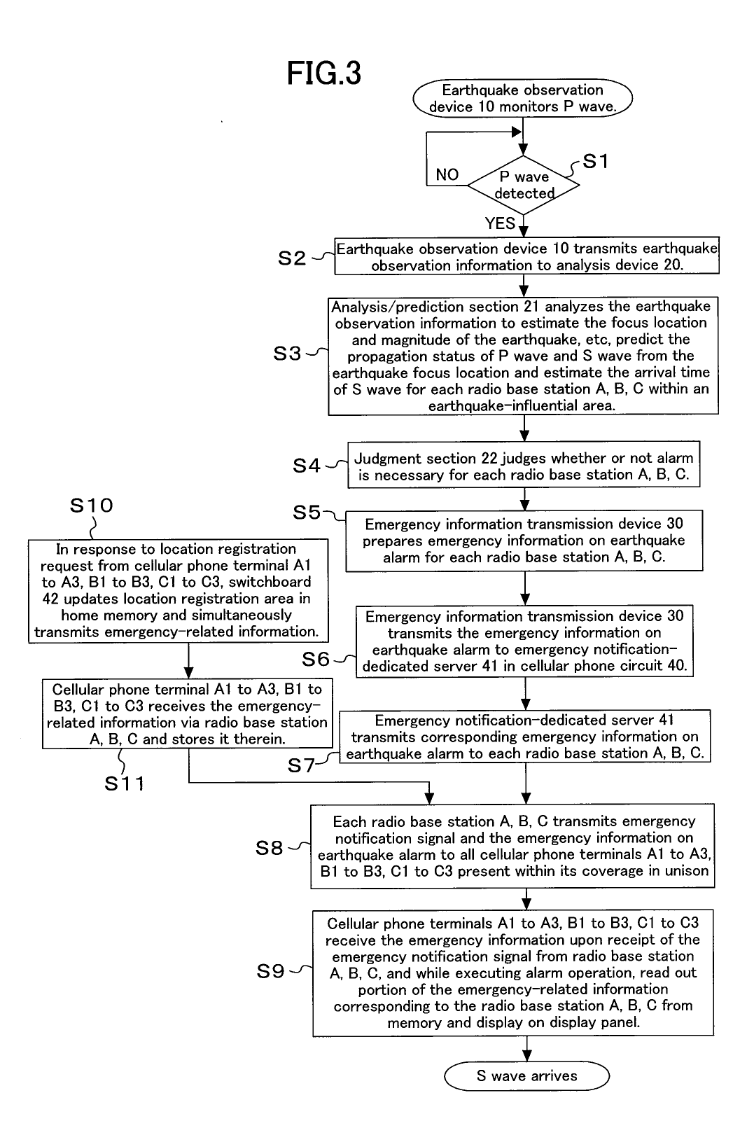

FIG. 3 is a flowchart showing the operation of the emergency information transmission system of Embodiment 2. In FIG. 3, steps S1 through S8 are the same as in FIG. 2. Description of these steps is therefore omitted here. In FIG. 3, to the operation flow in Embodiment 1, added are a step (S10) in which in response to a location registration request from any of the cellular phone terminals A1 to A3, B1 to B3 and C1 to C3, the switchboard 42 updates the location registration area in the home memory and simultaneously transmits emergency-related information to the cellular phone terminal and a step (S11) in which the cellular phone terminal A1 to A3, B1 to B3, C1 to C3 receives the emergency-related information via the radio base station A, B, C and stores the information therein.

In step S9, the cellular phone terminal A1 to A3, B1 to B3, C1 to C3 receives the emergency information upon receipt of the emergency notification signal, and while executing alarm operation, reads out the emergency-related information from its memory and displays the information on the display panel.

In Embodiment 2, each of the cellular phone terminals A1 to A3, B1 to B3 and C1 to C3 receives in advance emergency-related information at the time of update of the location registration area in the home memory. This eliminates the necessity of transmitting a large amount of emergency information at the time of notification of emergency such as an earthquake, and thus improvement in real-time property is expected.

### Embodiment 3

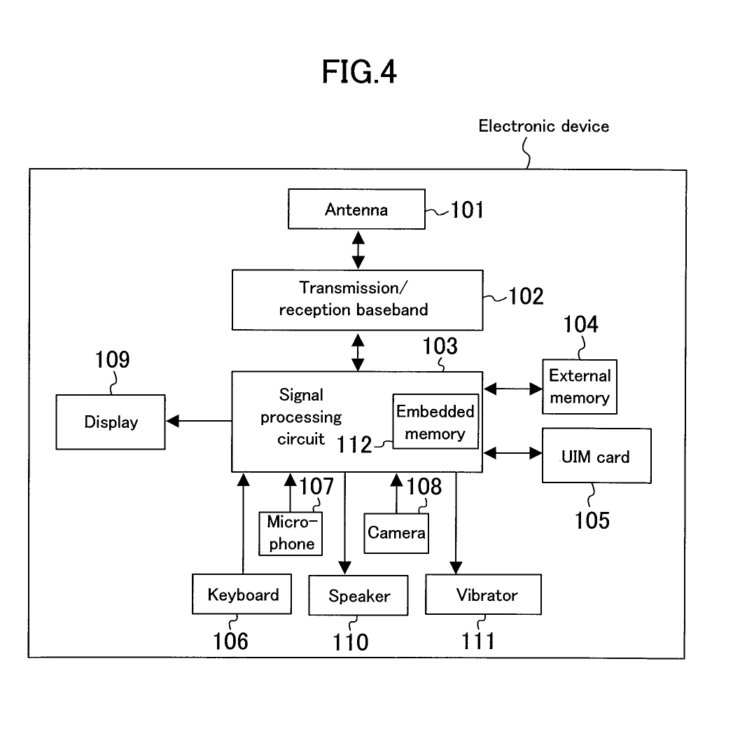

Embodiment 3 refers to an electronic device (information communication device) for implementing Embodiments 1 and 2 described above. FIG. 4 shows a configuration of such an electronic device. The electronic device of FIG. 4 includes an antenna 101, a transmission/reception baseband 102 for performing modulation/demodulation, a signal processing circuit 103 for performing audio coding/decoding and data processing, an external memory 104 such as an SD memory card and a UIM card 105 as memory elements, a keyboard 106 as an I/O interface, a microphone 107, a camera 108, a display 109, a speaker 110 and a vibrator 111.

An electronic device, such as any of the cellular phone terminals A1 to A3, B1 to B3 and C1 to C3, for implementing Embodiment 1 holds in its memory a common number or code dedicated to emergency notification used only at the time of notification of emergency such as an earthquake, in addition to the phone number set for each subscriber. As the memory for holding such a common number or code, any of the UIM card 105, an embedded memory 112 and the external memory 104 may be used.

As described in Embodiment 1, when an earthquake occurs, the emergency information transmission device 30 transmits emergency information varying among the radio base stations A, B and C via the cellular phone circuit 40. Once receiving their specific emergency information, the radio base stations A, B and C transmit an emergency notification signal and the emergency information to all the cellular phone terminals A1 to A3, B1 to B3 and C1 to C3 present within the coverages of the radio base stations A, B and C in unison. Each of the cellular phone terminals A1 to A3, B1 to B3 and C1 to C3 compares the received emergency notification signal with the common number or code dedicated to emergency notification held in its memory, and if judging that they match each other, receives the emergency information and gives an alarm by vibration (111), announces an alarm and the earthquake arrival time via the speaker 110, and/or displays earthquake alarm-related information such as the evacuation place on the display panel 109.

An electronic device, such as any of the cellular phone terminals A1 to A3, B1 to B3 and C1 to C3, for implementing Embodiment 2 performs the following operation in addition to the operation described above for Embodiment 1. That is, the switchboard 42 updates the location registration area in the home memory in response to a location registration request from any of the cellular phone terminals A1 to A3, B1 to B3 and C1 to C3, and simultaneously transmits emergency-related information to the cellular phone terminal. The cellular phone terminal A1 to A3, B1 to B3, C1 to C3 receives the emergency-related information via the radio base station A, B, C and holds the information therein. Once receiving an emergency notification signal from the radio base station A, B, C, the cellular phone terminal A1 to A3, B1 to B3, C1 to C3 reads out a portion of the emergency-related information described above corresponding to the radio base station A, B, C from its memory and displays the portion of the information on the display panel 109.

While the present invention has been described in preferred embodiments, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

What is claimed is:

1. An emergency information transmission system comprising:
an emergency information transmission device for transmitting emergency information varying among radio base stations; and
a radio base station for transmitting the emergency information received from the emergency information transmission device to all cellular phone terminals present within its coverage.

2. The emergency information transmission system of claim 1, wherein the radio base station has its unique number or code, and
the emergency information transmission device transmits the emergency information varying among radio base stations using the unique number or code.

3. The emergency information transmission system of claim 1, wherein the cellular phone terminals receive the emergency information after receipt of an emergency notification signal from the radio base station, and perform alarm operation.

4. The emergency information transmission system of claim 1, wherein the cellular phone terminals have a common number or code dedicated to emergency notification, and
the radio base station transmits the emergency information to all cellular phone terminals present within its coverage in unison by transmitting the common number or code dedicated to emergency notification to the cellular phone terminals as an emergency notification signal.

5. The emergency information transmission system of claim 1, wherein in response to a location registration request from a cellular phone terminal, a switchboard updates a location registration area in a home memory and simultaneously transmits emergency-related information to the cellular phone terminal via a radio base station, and the cellular phone terminal stores the received emergency-related information therein, and
the cellular phone terminal displays the emergency-related information when receiving an emergency notification signal from the radio base station.

6. The emergency information transmission system of claim 5, wherein the emergency-related information is information on an evacuation place or a dangerous place for each radio base station.

7. An electronic device for an emergency information transmission system comprising an emergency information transmission device for transmitting emergency information varying among radio base stations and a radio base station for transmitting the emergency information received from the emergency information transmission device to all cellular phone terminals present within its coverage in unison,
wherein the electronic device has a common number or code dedicated to emergency notification, and
receives the emergency information after receipt of the common number or code dedicated to emergency notification from the radio base station as an emergency notification signal and performs alarm operation.

8. An electronic device for an emergency information transmission system comprising an emergency information transmission device for transmitting emergency information varying among radio base stations and a radio base station for transmitting the emergency information received from the emergency information transmission device to all cellular phone terminals present within its coverage in unison,
wherein in response to a location registration request from a cellular phone terminal, a switchboard updates a location registration area in a home memory and simultaneously transmits emergency-related information to the cellular phone terminal via a radio base station, and the cellular phone terminal stores the received emergency-related information therein, and
the cellular phone terminal displays the emergency-related information when receiving an emergency notification signal from the radio base station.
